(19) United States
(12) Patent Application Publication
(10) Pub. No.: US 2006/0214500 A1
(43) Pub. Date: Sep. 28, 2006

(54) Wheel lighting system

(76) Inventors: Eric William Hall, Palmyra, NJ (US); Anthony Michael Chilbert, Lumberton, NJ (US)

Correspondence Address: WILLIAM STOFFEL, PMB 455, 1735 MARKET ST. - STE. A, PHILADELPHIA, PA, 19103-7502, US

(21) Appl. No.: 11/389,839

(22) Filed: Mar. 27, 2006

Related U.S. Application Data
(60) Provisional application No. 60/665,181, filed on Mar. 25, 2005.

(51) Int. Cl. B60B 21/00; B60B 25/00

(52) U.S. Cl. 301/95.102; 301/95.101

(57) ABSTRACT

A wheel assembly and lighting device preferably comprised of the following. A wheel comprised of: a rim and a central portion. The rim has an outside rim face and an inside rim face; the central portion of the wheel has a front wheel face and a back wheel face. The lighting device is comprised of a power source; a light mounted on the wheel. In an optional example embodiment, a passageway through the wheel the communicate from (a) the front face of the wheel to the back face of the wheel, (b) the outside rim face to the inside rim face and/or (c) thru the hub. The lights mounted in at least some passageways on the front face of the wheel. A means for connecting the power source and the light. Wires for connecting the power source and the light pass through the optional passageways.

### CROSS REFERENCE

This patent application is a regular patent application (non-provisional) that claims priority at least under 35 U.S.C. 119(e) from the U.S. provisional patent application Ser. No. 60/665,181 Filing date Mar. 25, 2005, entitled Wheel lighting System, by the same inventors, Anthony M. Chilbert and Eric W. Hall, atty docket CHI04-001, which disclosure is incorporated herein by reference for all purposes.

### BACKGROUND OF INVENTION

1) Field of the Invention

This invention relates generally to a system for lighting wheels and rims of wheels and can be more particularly related to automobiles or motorcycles.

2) Description of the Prior Art

Devices for illuminating the wheels of an automobile both add to the aesthetic appeal of the automobile and increase its safety by improving its visibility. While there are numerous examples of wheel lighting devices in the prior art, these can be improved upon.

The importance of these devices is evidenced by the extensive technological development directed to the subject, as documented by the relevant patent and technical literature. The closest and apparently more relevant technical developments in the patent literature can be gleaned by considering the following.

U.S. Pat. No. 6,612,726—Gloodt, et al. Sep. 2, 2003—Illuminated automobile wheels. An assembly for providing illumination to an automobile wheel having an at least partially transparent wheel covering. The assembly includes a bracket for securing to the a non-rotating portion of an automobile wheel and a light emitting diode or diode array operationally connected to the bracket. A rechargeable battery is electrically connected to the light emitting diode and the light emitting diode, when energized, shines light through the at least partially transparent wheel covering when the wheel covering is rotating.

U.S. Pat. No. 5,357,238 Terada Oct. 18, 1994—Wheel marker for vehicle including solar cell. —A wheel marker including a solar cell and disposed on a wheel cap so as to allow the present rotating state of a wheel of a vehicle to be visually recognized from a remote location includes as essential components a light emitting section radially extending toward the center of the wheel cap, a solar cell electricity generating section circumferentially extending around the central part of the wheel cap, a brightness detecting sensor disposed at the center of the wheel cap on the front side, an inverter disposed on the rear side, and a battery disposed on the rear side of the wheel cap and adapted to be charged by the solar cell. The light emitting section includes a light emitting element which usually comprises an electroluminescence element or a light emitting diode. In response to an output from the brightness detecting photosensor, the inverter is activated to turn on or off the battery. To turn off the battery when there is no need of activating the light emitting section, e.g., in the daytime, a power switch is disposed in position on the front surface of the wheel cap.

U.S. Pat. No. 6,220,733 Gordon Apr. 24, 2001—Vehicle wheel lighting system. Abstract—A light system for a vehicle wheel comprising at least one light source, at least one reflective body and an electrical power source operably coupled to the light source. The light source directs light toward the reflective body. In a preferred embodiment several spokes of a spoked wheel are replaced with reflective bodies, and a plurality of LEDs mounted in the inner hub of the spoked wheel direct light toward each reflective body spoke.

U.S. Pat. No. 6,030,106—Johnson—Feb. 29, 2000—Light display for a vehicular wheel.—A lighting assembly is mounted to a vehicular wheel in such a manner that a plurality of lamps are positioned on the side of the wheel attached to the wheel rim. Wires connect the lamps to a power source mounted onto the wheel rim inside of the tire. A hand-held, or panel mounted remote control device is used to communicate with the power source, which also has a receiver and control circuit. Through this control means, the lights may be made to blink in unison, sequentially or in any manner desired and to change the light output magnitude. An important aspect of the invention is that the apparatus may be fitted to existing vehicles such as cars, trucks and motorcycles.

Other related patents include:

U.S. Pat. No. 6,644,839 B2—Lee;

U.S. Pat. No. 6,030,106—Johnson

U.S. Pat. No. 6,220,733—Gordon

U.S. Pat. No. 6,382,820—Chung

U.S. Pat. No. 6,116,762 Johnson

U.S. Pat. No. 5,497,302—O'Donnell

U.S. Pat. No. 6,601,979 Byrd, et al.

U.S. Pat. No. 6,322,237 Lee

U.S. Pat. No. 6,168,301 Martinez, et al.

### SUMMARY OF THE INVENTION

The example embodiments of the present invention provides a structure and a method of manufacturing a lighted wheel assembly which is characterized as follows.

A first example embodiment of a wheel assembly with a lighting device comprises:

a wheel comprised of: a rim and a central portion;
the rim has an outside rim face and an inside rim face;
the central portion comprised of a hub and spokes; the spokes connected to the rim and the hub;

a power source attached to the wheel;

at least a light attached to the wheel;

a connecting means for connecting the power source and the light.

A second example embodiment of a wheel assembly comprises the first embodiment and further comprises:

the hub has a hub hole having a inside hub hole wall; and the hub having an outside hub wall;

a hub passageway communicating between inside hub wall and the outside hub wall;

the power source mounted in the hub hole;

the conducting means is comprised of at least a wire; the wire passes through the hub passageway.

A third example embodiment of a wheel assembly comprises the first embodiment and further comprises:

a rim passageway through the rim communicating from the outside rim face and the inside rim face;

the power source attached to the outside rim face;

the conductive means comprises at least a wire passing through the rim passageway.

A forth example embodiment of a wheel assembly comprises the first embodiment and further comprises:

the hub has a hub hole having a inside hub hole wall; and the hub having an outside hub wall;

a hub passageway communicating between inside hub wall and the outside hub wall;

a rim passageway through the rim communicating from the outside rim face and the inside rim face;

the power source attached to the outside rim face;

the conductive means comprises at least a wire passing through the rim passageway or the hub passageway.

A further example embodiment of a lighted wheel assembly is comprised of
a wheel is comprised of: a rim and a central portion; the rim has an outside rim face and an inside rim face; the central portion has a front wheel face and a back wheel face;

a lighting device comprised of a power source; and at least a light mounted on the wheel;

at least a passageway at least through the rim;

a conducting means for connecting the power source and the light; the power source is positioned on the rim;

the conducting means for connecting the power source and the light passes through the passageway.

In an aspect, the passageway is (a) a wire passageway that communicates from the outside rim face to the inside rim face; or (b) rim light passageway that communicates from the outside rim face to the inside rim face;

the lights mounted in at least an aperture on the front wheel face or the inside rim face of the wheel.

The above and below advantages and features are of representative embodiments only, and are not exhaustive and/or exclusive. They are presented only to assist in understanding the invention. It should be understood that they are not representative of all the inventions defined by the claims, to be considered limitations on the invention as defined by the claims, or limitations on equivalents to the claims. For instance, some of these advantages may be mutually contradictory, in that they cannot be simultaneously present in a single embodiment. Similarly, some advantages are applicable to one aspect of the invention, and inapplicable to others. Furthermore, certain aspects of the claimed invention have not been discussed herein. However, no inference should be drawn regarding those discussed herein relative to those not discussed herein other than for purposes of space and reducing repetition. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

Note that the descriptions and names on the figures are non-limiting and are examples only.

The features and advantages of the lighting system according to the embodiments of the present invention will be more clearly understood from the following description taken in conjunction with the accompanying drawings in which like reference numerals designate similar or corresponding elements, regions and portions and in which:

FIG. 1 is a perspective view of a wheel assembly having a lighting device according to an general example embodiment of the invention.

FIG. 2A is a plan view of the back side of the wheel according to a first embodiment of the invention.

FIG. 2B is a cross sectional view along axis 2B in FIG. 2A according to a first embodiment of the invention.

FIG. 3A is a plan view of the back side of the wheel according to second embodiment of the invention.

FIG. 3B is a cross sectional view along axis 3B in FIG. 3A according to a second embodiment of the invention.

FIG. 4A is a plan view of the back side of the wheel according to a third embodiment of the invention.

FIG. 4B is a cross sectional view along axis 4B in FIG. 4A according to a third embodiment of the invention.

FIG. 5A is a plan view of the back side of the wheel showing a fourth embodiment where the rim has a hub passageway 28 and the hub has a hub passageway 90.

FIG. 5B is a cross sectional view along axis 5B in FIG. 5A showing a fourth embodiment where the rim has a hub passageway 28 and the hub has a hub passageway 90.

FIG. 6 is a sectional view of a wheel assembly (similar to as shown in FIG. 1) having a lighting device according to an example embodiment of the invention.

FIG. 7 shows a side view a wheel assembly having a lighting device according to an example embodiment of the invention.

FIG. 8 shows a top down view of the back side of the wheel assembly having a lighting device shown in FIG. 1 according to an example embodiment of the invention.

FIG. 9A shows a cross sectional view of a wheel assembly having a lighting device according to an example embodiment of the invention.

FIG. 9B shows a close up cross sectional view the rim (wire) passageway (shown in FIG. 9A) of a wheel assembly having a lighting device according to an example embodiment of the invention.

FIG. 9C shows a close up cross sectional view the light passageway of a wheel assembly having a lighting device according to an example embodiment of the invention.

FIG. 10 shows an example electrical schematic diagram of the light circuit according to an example embodiment of the invention.

FIG. 11 is a cross sectional view of a wheel assembly (similar to as shown in FIG. 1) having a lighting device where the battery is attached to the inside rim face 12B according to an example embodiment of the invention.

### DETAILED DESCRIPTION OF THE EXAMPLE EMBODIMENTS

This patent application is a regular patent application (non-provisional) that claims priority at least under 35 U.S.C. 119(e) from the U.S. provisional patent application Ser. No. 60/665,181 Filing date Mar. 25, 2005, entitled Wheel lighting System, by the same inventors, atty docket CHI04-001, which disclosure is incorporated herein by reference for all purposes.

The example embodiments of the present invention will be described in detail with reference to the accompanying drawings. Note, the figures are not to scale or proportion.

The example embodiments of the present invention provides a system for illuminating a wheel.

### Definitions

A ‘rim’ comprises an annular member of a wheel that either engages the ground directly or supports a ‘tire’ which engages the ground. A ‘felly’ is a portion of a rim between the rim flanges over which a tire can be positioned.

The term “Light emitting diode” (LED) is used in the description, but any device that gives off light can be used.

“Axial” and “axially” means the lines or directions that are parallel to the axis of rotation of the tire.

“Bead means that part of the tire comprising an annular tensile member wrapped by ply cords and shaped, with or without other reinforcement elements such as flippers, chippers, apexes, toe guards and chafers, to fit the design rim.

“Equatorial Plane (EP)” means the plane perpendicular to the tire's axis of rotation and passing through the center of its tread.

“Radial” and “radially” means directions radially toward or away from the axis of rotation of the tire.

A. Overview of Four Example Embodiments

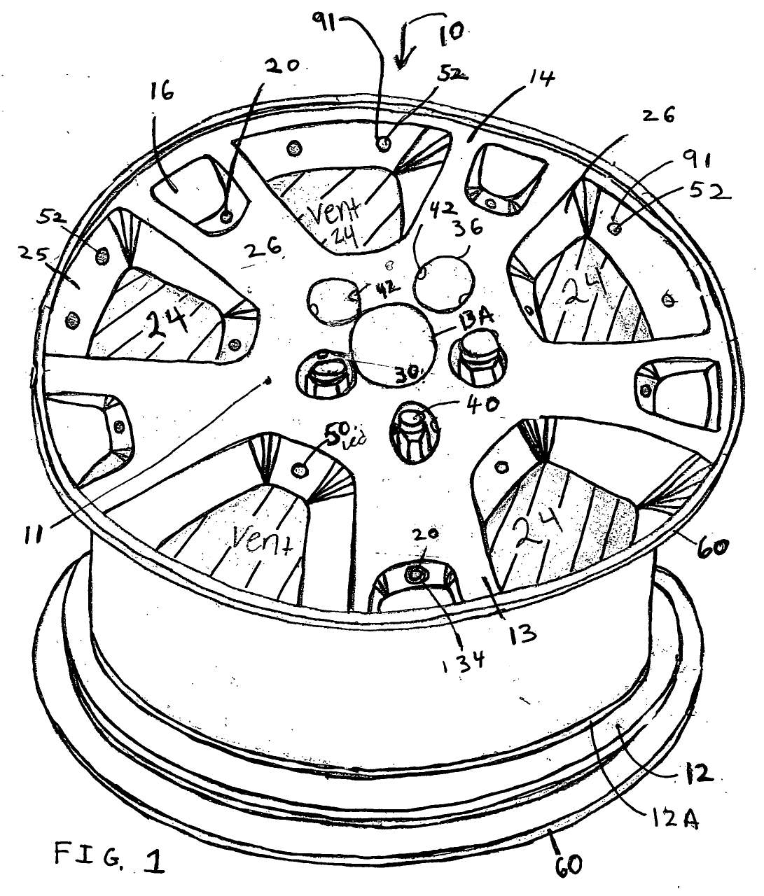

There are at least four example embodiments of the lighted wheel assembly generally illustrated in FIGS. 1, 2A, 2B, 3A, 3B, 4A and/or 4B.

These example embodiment show various options of the wheel, power source, passageways (e.g., rim passageway 90, hub passageway 28, rim light passageway 91), light and conducting means for connecting the power source to the light.

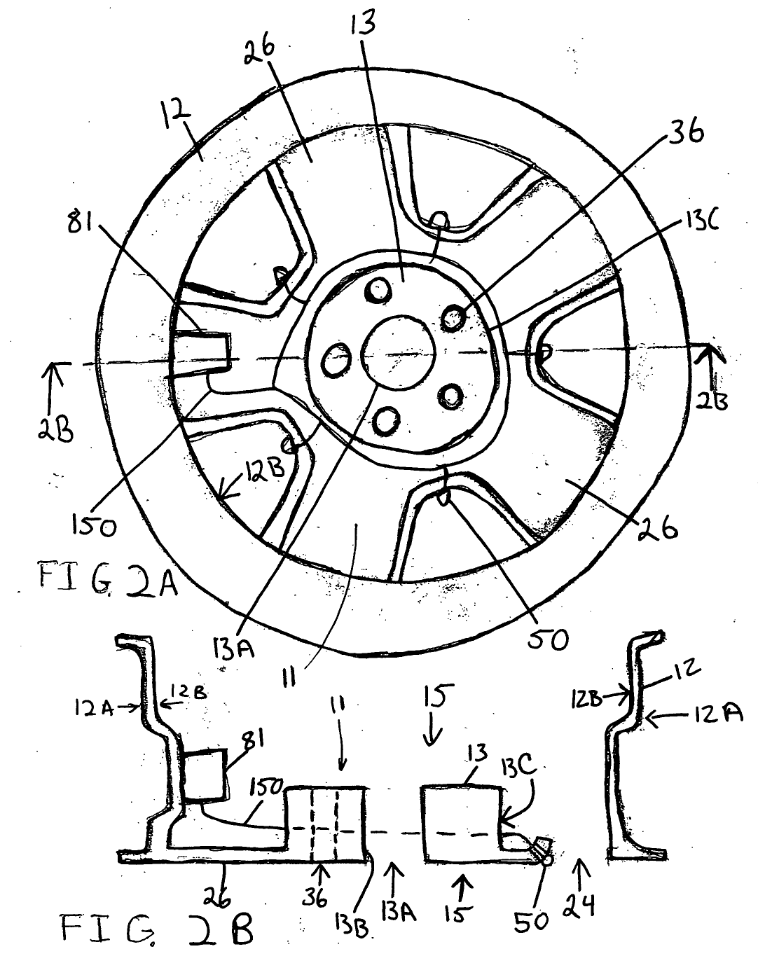

FIG. 2A, 2B, 3A, 3B, 4A and 4B relate to perspective view in FIG. 1. However, FIGS. 2A, 2B, 3A, 3B, 4A and 4B are simplified and do not show all the details shown in FIG. 1 and do not correspond exactly. For example FIGS. 2A, 2B, 3A, 3B, 4A and 4B do not show all lights and exact placements in FIG. 1.

B. General 3D Figure of Lighted Wheel

FIG. 1 shows a three dimensional illustration of an example wheel assembly 10 and lighting device. Note that none of the figures are to scale/proportion.

A wheel 10 is preferably comprised of: a rim 12 and a central portion 11. The central portion 11 can connect the rim 12 to a vehicle. The central portion 11 is preferably comprised of spokes 26 and center hub 13. Vents (openings) 24 can define the spokes 26. The rim 12 can have an annular flange 60. The rim 12 has an outside rim face 12A (toward a tire) and an inside rim face (toward the hub 13). For embodiments where the wheel is attached to a motor vehicle, the front wheel face points outward away from the side where a car and axle would be. The back wheel face faces the axle.

FIG. 1 show the rim light passageway 91 having a light 52.

FIG. 1 will be discuss in more detail below.

C. First Example Embodiment (No Passageways)

FIG. 2A is a plan view of the back side of the wheel. FIG. 2B is a cross sectional view along axis 2B in FIG. 2A. FIGS. 2A and 2B relate to perspective view in FIG. 1. However, FIGS. 2A and 2B are simplified and do not show all the details shown in FIG. 1 and do not correspond exactly. For example FIGS. 2A and 2B do not show all lights and exact placements in FIG. 1.

FIGS. 2A and 2B show a first embodiment where there are no passageways in the rim 12 or the hub 13. FIGS. 2A and 2B show a wheel 10 comprised of: a rim 12 and a central portion 11. The rim 12 has an outside rim face 12B and an inside rim face 12A. The central portion is comprised of a hub 13 and spokes 26. The spokes 26 connect to the rim 12 and the hub 13. A power source 81 is attached to the wheel. In this example, the power source 81 is attached to the inside rim face 12B. The power source can also comprise a control mechanism (e.g., receiver and controller). At least a light 50 is attached to the wheel 10. In this example the light 50 is mounted on or in a spoke 26 in vent opening 24. Lights can be mounted in other locations such as shown in the other figures. A wire 150 is used to connect the power source 81 and the light 50. The power source can also include a receiver to receive radio signals to control the lights, such as on/off and lighting schemes and sequences.

D. Second Embodiment—Hub Passageway

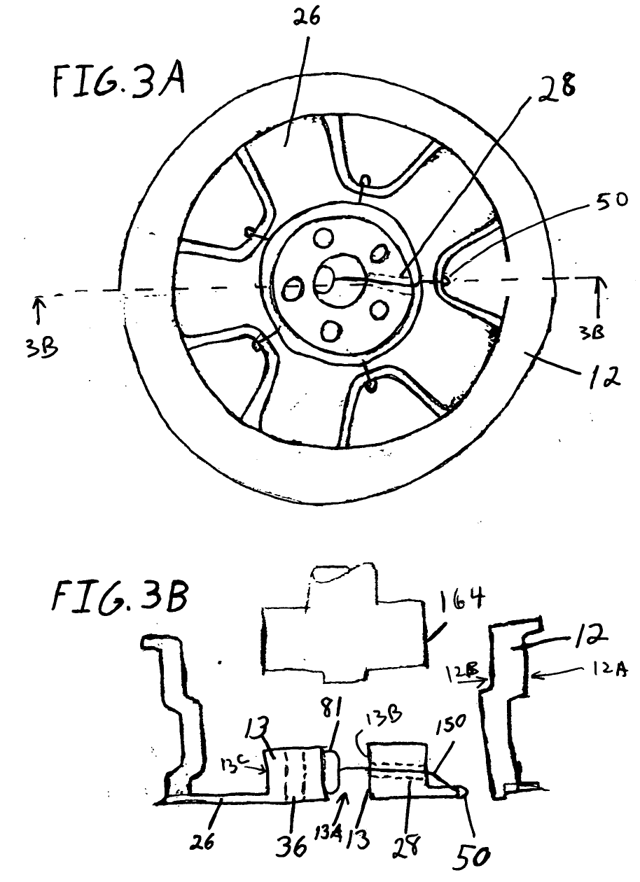

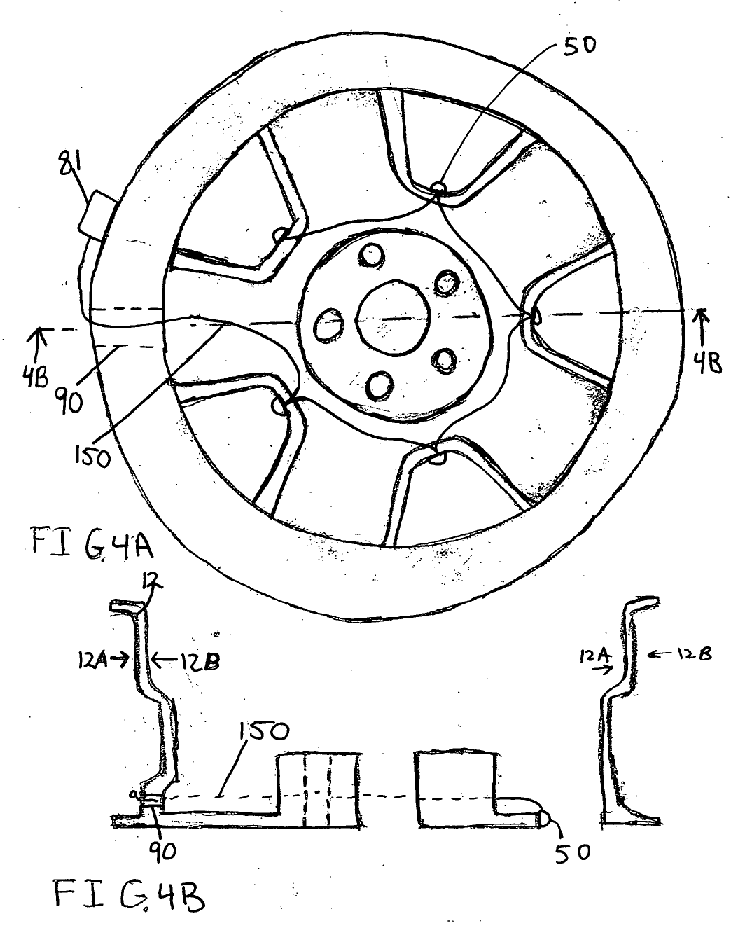

FIG. 3A is a plan view of the back side of the wheel. FIG. 3B is a cross sectional view along axis 3B in FIG. 3A.

FIGS. 3A and 3B show a second embodiment where the hub has a hub passageway 28 through which wires can pass. FIGS. 3A and 3B show the hub 13 has a hub hole 13A having an inside hub hole wall 13B. The hub has an outside hub wall 13C.

A hub passageway 28 communicates between inside hub wall 13B and the outside hub wall 13C. The hub passageway can be a groove, channel or a hole.

The power source 81 is mounted in the hub hole 13A.

The conducting means is comprised of at least a wire 150. The wire 150 passes through the hub passageway.

FIG. 3B shows an axle 164 that can attach to the hub 13 typically using bolts and lug nuts.

E. Third Embodiment—Rim (Wire) Passageway

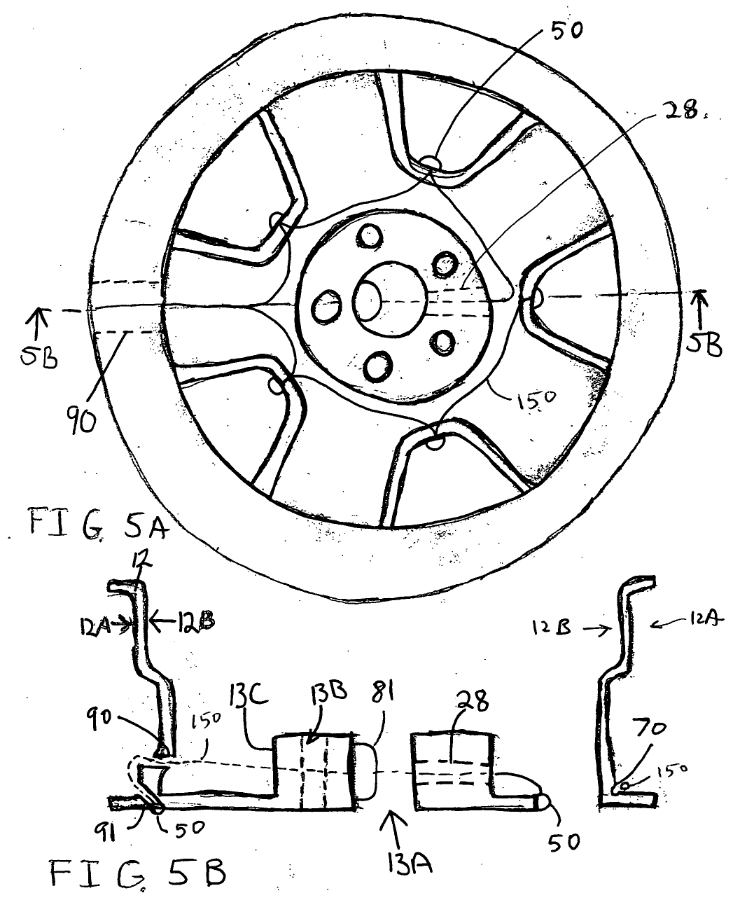

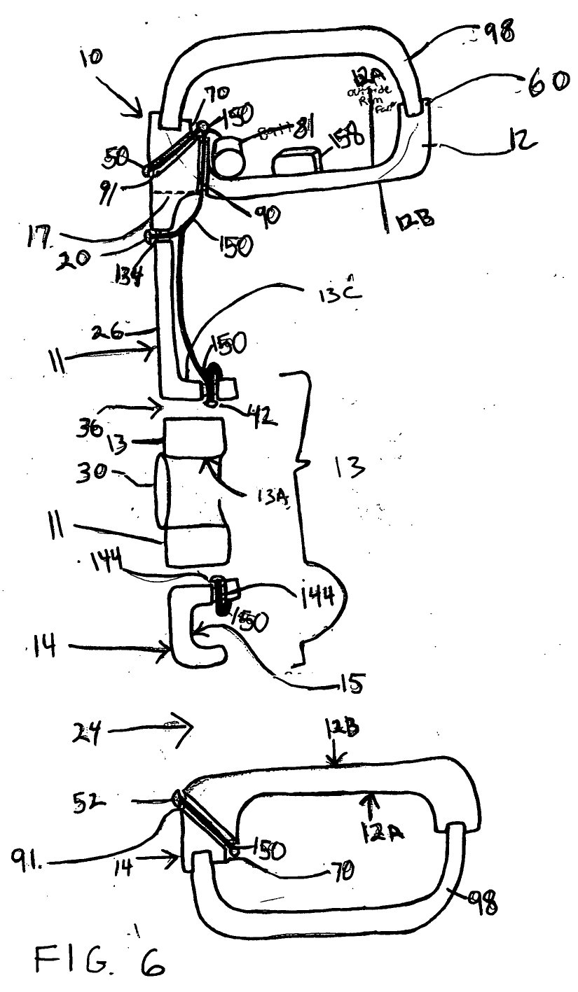

FIG. 4A is a plan view of the back side of the wheel. FIG. 4B is a cross sectional view along axis 4B in FIG. 4A.

FIGS. 4A and 4B show a third embodiment where the rim has a rim passageway 90 through the rim 12. The rim passageway 90 through the rim 12 communicates from the outside rim face 12B and an inside rim face 12A. The power source 81 is attached to the outside rim face 12B.

The conductive means comprises at least a wire 150 passing through the rim wire passageway 90.

F. Fourth Example Embodiment—Hub has a Hub Passageway

FIG. 5A is a plan view of the back side of the wheel. FIG. 5B is a cross sectional view along axis 5B in FIG. 5A.

FIGS. 5A and 5B show a fourth embodiment where the rim has a hub passageway 28 and the hub has a hub passageway 90. Wires preferably pass thru the hub passageway 28 and hub passageway 90.

The hub passageway 28 communicates between inside hub wall 13B and the outside hub wall 13C. The rim passageway 90 through the rim 12 communicating from the outside rim face 12B and an inside rim face 12A.

The power source 81 attached to the outside rim face 12B.

The conductive means comprises at least a wire 150 passing through the rim passageway 90 or the hub passageway 28.

The central portion 11 has a front wheel face 14 and a back wheel face 15; the light is mounted on the front wheel face.

FIG. 5B shows the groove 70 where a wire 150 can run round the rim. The Rim light passageway 91 also allows a wire to pass from the out side rim face 12A to the from face.

### II. Example Embodiments

A. Table of Elements

The table below is a list of some of the element names and element numbers.

TABLE
some elements

| # | name |
|---|---|
| 10 | wheel |
| 11 | central portion of the wheel 10 (e.g., spokes and hub) |
| 12 | rim |
| 12A | outside rim face (faces tire) |
| 12B | inside rim face (typically faces axle) |
| 13 | hub |
| 13A | hub center hole (hub hole) |
| 13B | a inside hub hole wall |
| 13C | outside hub wall 13C |
| 14 | front wheel face |
| 15 | back wheel face |
| 16 | recess in front face (decoration) |
| | dashed line estimating the boundary between the rim and central |
| 17 | portion |
| 20 | LED in recess |
| 24 | vent (opening) |
| 25 | vent sidewall on central portion outside. |
| 26 | spoke |
| 28 | Hub passageway |
| 30 | solar cell |
| 32 | rectifier |
| 36 | lug hole |
| 40 | lug nut |
| 42 | LED on lug hole sidewall |
| 50 | LED in sidewall of rim 12 |
| 52 | LED in sidewall of rim 12 |
| 52A | light flange |
| 54 | led in sidewall of spoke 26 |
| 60 | flange |
| 62 | felly |
| 64 | bead seat |
| 68 | bead hump |
| 70 | groove (for wire) |
| 70A | groove hole |
| 78 | inclined surface |
| 81 | battery |
| 86 | wheel well |
| 90 | rim (wire) passageway |
| 90A | tapered opening |
| 90B | taper opening 91B on the front face |
| 91 | rim light passageway (inside rim face to outside rim face) |
| 91A | wide tapered opening on vent hole 91 |
| 91B | narrow vent opening 91B. |
| 95 | sealant |
| 98 | tire |
| 102 | switch |
| 130 | cavity in backside 15 of central portion 11 |
| 134 | hole between cavity 130 and recess 16 |
| 138 | hollow in central portion between lug holes |
| 140 | vent Light hole (bottom) |
| 144 | lug light hole |
| 150 | wire (e.g., in Groove 70 and on wheel) |
| 154 | tunnel to hollow 138 |
| 158 | light control mechanism(controls, switch, receiver) |
| 160 | ground rivet |

B. Three Dimensional Illustration of Example Wheel Assembly

Referring to FIGS. 1 and 6, a three dimensional illustration of a wheel assembly and lighting device are shown. Note that none of the figures are to scale/proportion.

A wheel 10 is preferably comprised of: a rim 12 and a central portion 11. The central portion 11 connects the rim to the vehicle. The central portion 11 is preferably comprised of spokes 26 and center hub 13. Vents (openings) 24 define the spokes 26. The rim 12 has an annular flange 60. The rim 12 has an outside rim face 12A and an inside rim face 12B. The wheel has a front wheel face 14 and a back wheel face 15. For embodiments where the wheel is attached to a motor vehicle, the front wheel face points outward away from the side where a car and axle would be. The back wheel face faces the axle. FIG. 1 shows an optional solar cell 30 in the center hub hole 13A.

FIG. 6 is a cross sectional view thru a wheel similar to the example wheel shown in FIG. 1. FIG. 6 is not exactly like FIG. 1. For example FIG. 6 does not show the decorative recesses 16 as in FIG. 6.

As shown in the combination of FIGS. 1, 6 and 7, in an embodiment the central portion 11 of the wheel is comprised of spokes 26 and a center hub 13. Vent openings 24 can be defined by the spokes 26 and rim/vent sidewalls 25.

Recesses 16 are in the front wheel face 14. The recesses 16 are optional and are decorative. Lights 20 can be mounted in the recesses.

A optional solar cell 30 preferably is fixed in the center of the wheel. The solar cell 30 can be mounted in a hole in the wheel center hub.

Lug holes 36 are in the central portion 11 (e.g., hub 13). LED 42 preferably are mounted in the lug holes. The LEDs 42 are both decorative and increase safety by illuminating the lug hole and lug nuts 40 (e.g., in case of changing a tire/wheel or making car more visible at night).

Lights (e.g., LED) (e.g., 20, 50, 52 54, etc) are mounted on the wheel especially on the front wheel face 14. The LEDs can be mounted anywhere on the wheel. The LED are preferably mounted on the vent sidewalls, lug nut holes, in recesses. The lights preferably are visible from the front side of the wheel (away from the axle).

As seen in FIGS. 1 and 6, lights 42 can be mounted in the lug nut holes 36.

C. FIG. 6

FIG. 6 is a cross sectional view of a wheel assembly (similar to as shown in FIG. 1) having a lighting device according to an example embodiment. FIG. 6 shows an example wheel 10 comprised of rim 12 and central portion 11. The dashed line 17 is an estimate of the boundary between the rim and the central portion. The central portion has a front face 14 and a back face 15. The rim has a outside rim face 12A and an inside rim face 12B.

FIG. 6 shows two types of passageways 90 91. First, the wire wire passageway 90 passes thru the rim 12 from the outside rim face 12A to the inside rim face 12B. Wires can pass thru the wire passageway to connect to light 20 42 or to other wires/devices.

Second, the rim light passageway 91 connect the outside rim face 12A with the inside rim face 12B. Optionally the rim light passageway can angle down more and pass thru the central portion and communication from the outside rim face 12A to the front face 14 of the central portion 11. The wire passageway 90 and the rim light passageways are air tight to prevent air from leaking from the tire. Preferably the passageways communicate with the outside rim face are at least partied filled with sealer.

A third passageways, the light holes 134 and lug nut holes 144 pass thru the wheel, such as thru the central portion 11 to mount lights.

FIG. 6 shows the tire 98 seated on a bead on a flange 60 on the rim 12. Wire 15 can sit in a groove and extend around the circumference of the rim. Rim light passageways 91 are placed where lights 50 52 are desired.

A battery 81 can be mounted on the outside rim face 12A. The battery is connected to the wire 150. A light control mechanism(controls, switch, receiver) 158 can be mounted on the outside rim face 12A.

An optional solar cell 30 is position in a center hole in the wheel.

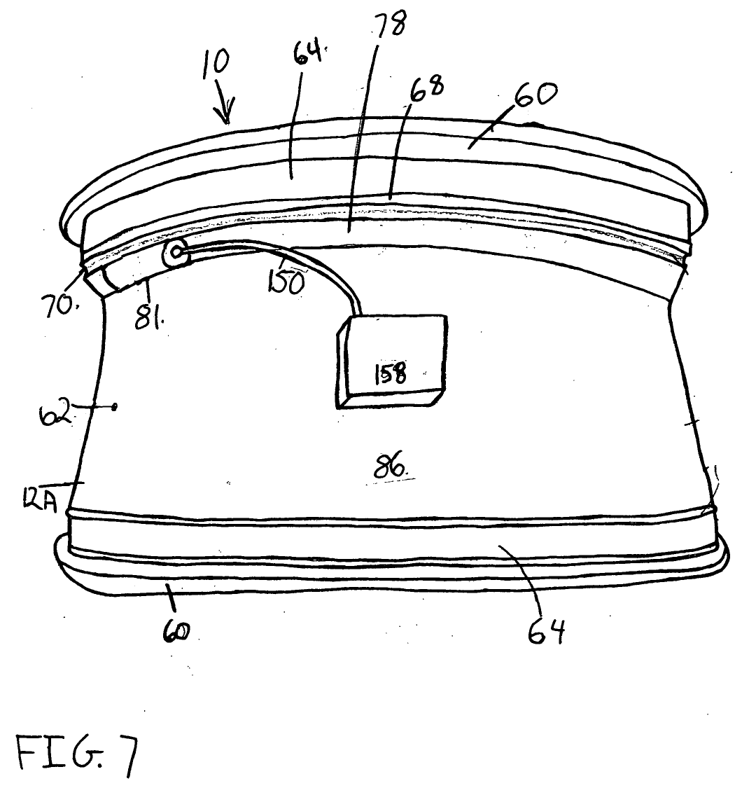

D. FIG. 7

FIG. 7 shows a perspective side view of the wheel 10.

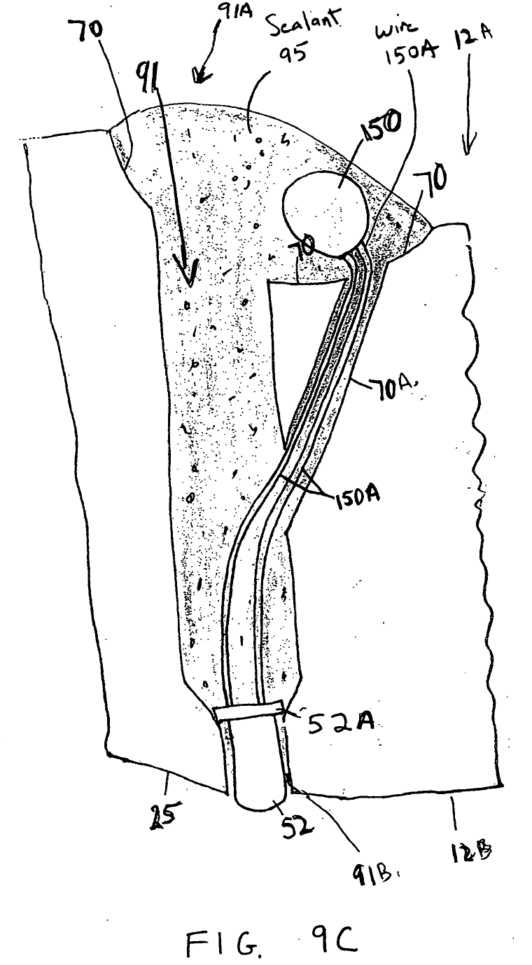

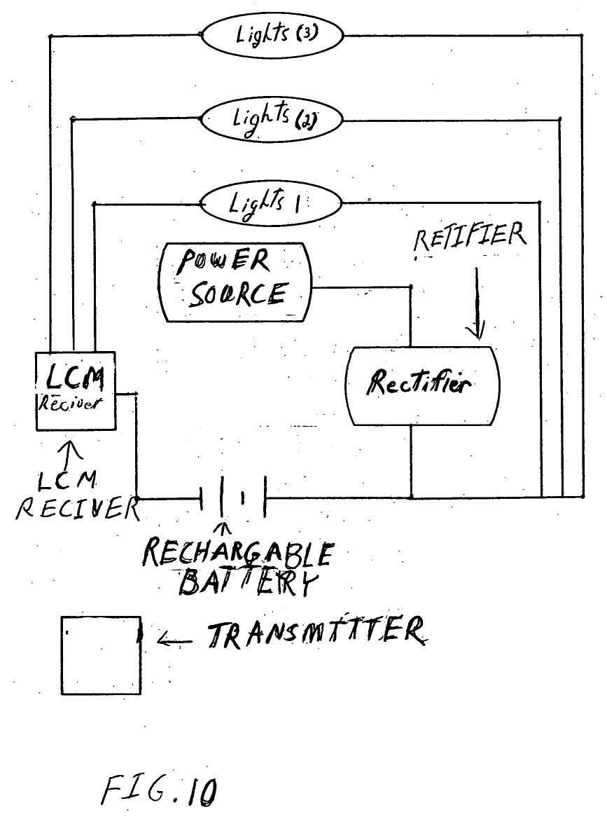

Referring to FIGS. 7 and 9A, the outside rim face 12A can be comprised of a bead seats 64, flanges 60, bead humps 60, and an inclined surface 78. The bead hump is often used to help keep the tire bead seated in the bead seat.

More preferably the power source, such as battery 81, is fixedly positioned on the outside rim face and enclosed by a tire 98.

Referring to the FIG. 7, the power source 81 is fixedly positioned on the outside rim face 12A. The battery 81 and control box 158 can be mounted using adhesive, such as a polymer or tape. Another option is to encase the battery and/or control box in a metal band that extends around the circumference of the rim. Wires 150 connect the batteries, control box 158 and lights.

In an option, a circumferential groove 70 is in the rim face 12A. The groove 70 is used to secure wires 150 that are used to connect to the lights and other circuitry.

Preferably wires sit in the groove 70 and are secured in the groove preferably using an resin or other sealer.

In other options, the wires and power sources and control boxes are attached using fastening hooks (e.g., Velcro™), glue, tape, etc. to the outside rim face 12A.

A light control module (can be part of the control mechanism 158) is preferably mounted on the annular rim 12. The light control module varies the frequency of the light (turn on and off). A radio receiver (can be part of the control mechanism 158) can mounted on the rim.

Preferably the battery and light control module (LCM) and any other devices are positioned on the annular rim to balance the rim.

A radio transmitter (remote control) can be used to control the lights. The radio transmitter can be hand held or mounted inside car e.g., on dash. The radio transmitter can have modes to control speed, sound, pattern, of the lights. The radio transmitter can the lights on or off.

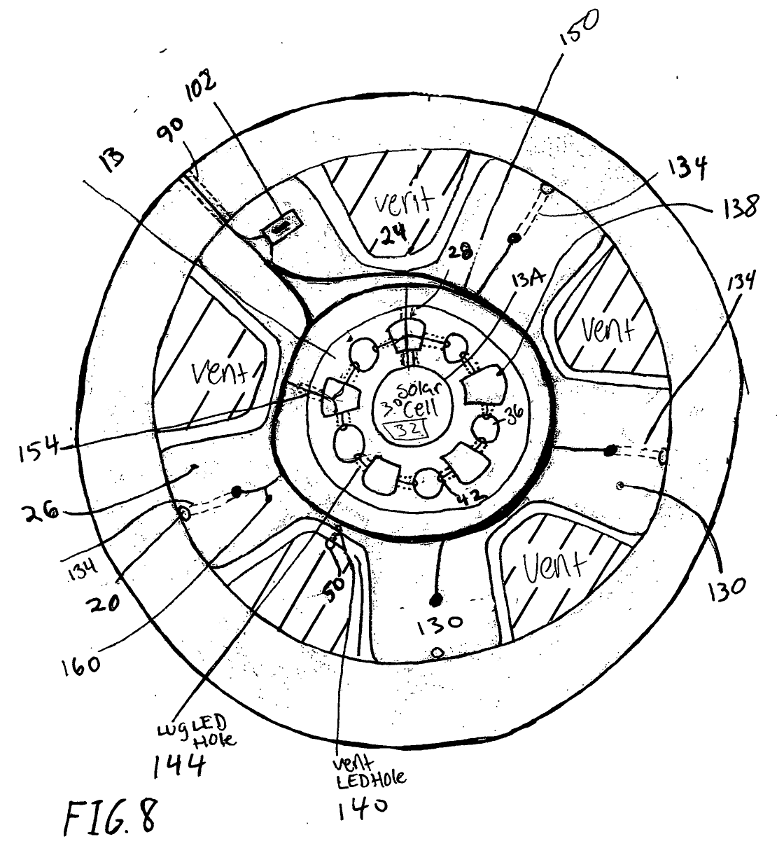

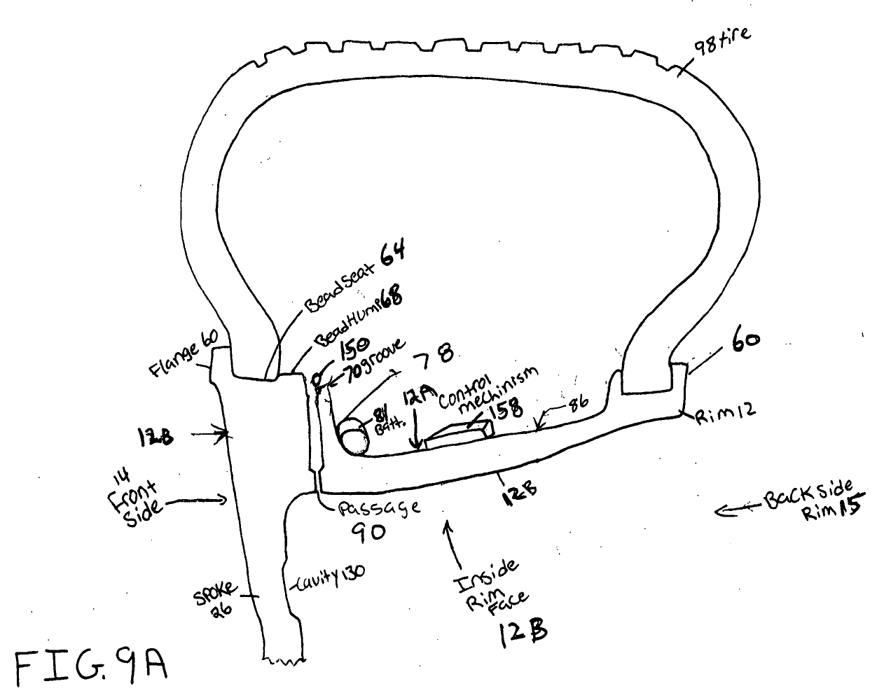

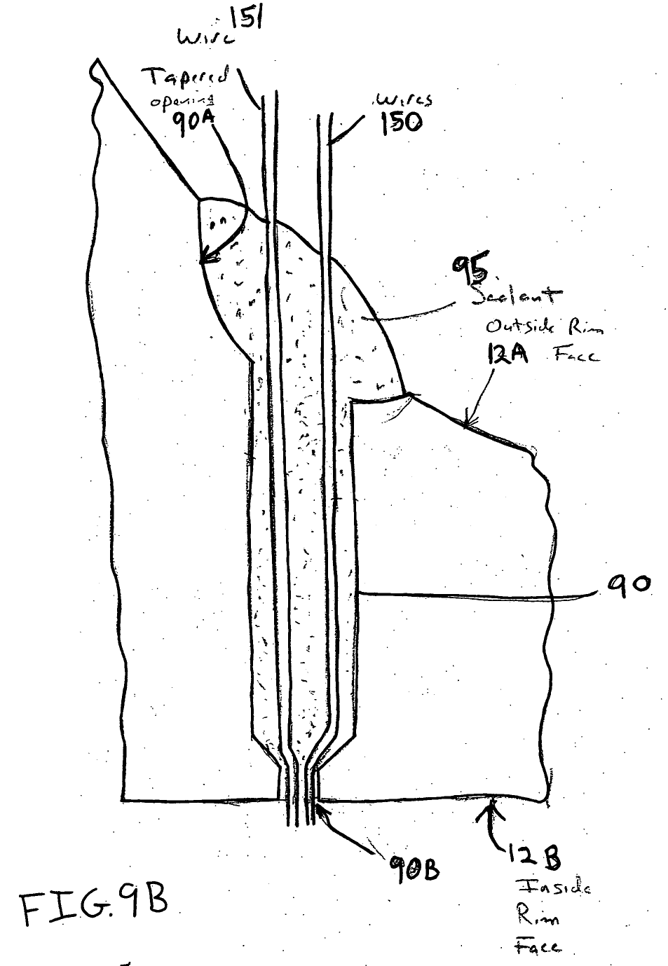

E. FIG. 8

FIG. 8 shows a top down view of the backside of the wheel.

FIG. 8 shows the wheel has a center hole where an axle end would pass thru. The power source 30 is preferably mounted in the center hole. The power source 30 can be a generator, mechanical generator, solar cell. The power source is connect to the wiring system. In an option, the only power source for the lighting system can be a generator 30 (and no battery 81).

The spokes 26 have back side cavities 130 or channels in the back side.

Referring to FIG. 8, the wheel has a center hole 13A. The solar cell 30 mounted in the center hole 110. An rectifier 32 can be mounted on the back of the solar cell 30.

FIG. 8 and FIG. 9A show wire passage 90 and light hole 134.

Optional switch 102 is mounted in a cavity 130. Wires 150 151 pass thru passage 90 from the outside rim face 12A (e.g., from the groove, battery, control box) and feeds the various LED's (50 42, etc). A ground rivet 160 grounds the wires 151.

Wires 150 circle the center hole and pass thru the center hole 154, The wires also can pass into the hollow 138 thru the tunnel 154. Wires (not all shown) pass from the hollow 138 thru the lug LED hole 144 to connect to the Lug LED 42.

A Vent LED hole 140 communicates from the cavity 130 to the vent sidewall 25. A LED 50 is mounted in the Vent LED hole 140 on the vent sidewall side.

Light holes 134 (e.g., 134 figure C1) can communicate between the wheel front face 14 and the wheel backside face 15. Lights are preferably secured in the light holes. Wires are position within portions of the light holes.

FIG. 8 shows an example hub passageway 25 where a wire passes from the optional solar cell 30 or other power source to the loop of wire circling the hub 12. The hub passageway does not have to be straight and can be comprised of any number of passageways and hollows.

F. Rim Wire Passageway

Referring to FIG. 9A, a rim wire passage 90 in the rim communicates between the inside rim face 12B and outside rim face 12A. The wire passage 90 preferably contains wires that connect the power supply and the wires on the inside 12B of the rim (see FIG. 8). Preferably, the passage 90 is not in the bead seat 64 and the flange 60. A sealing device is placed in the rim wire passage to keep air in the tire. The sealing device can be a polymer, or one way valve, etc. but is not limited to this.

Still referring to FIG. 9A, a groove 70 is in the rim whereby wires 150 are positioned within the groove 70. The groove does not necessarily have to be totally around the rim. The wires 150 in the groove connect the power supply to lights 52 (figure (9C) mounted in the vent sidewall holes 91

Still referring to FIG. 9A, the rim is preferably comprised of a circumferential bead seat 64, bead hump 68, inclined surface 78, and wheel well 86. The bead of the tire 98 sits in the bead seat.

In general, the passageways in the wheel are comprised of openings that pass thru walls or sections of the wheel, such as light holes and passageways.

FIG. 9A shows battery 81 mounted on the outside rim face 12A.

Still referring to FIG. 9A, there is shown a profile of the rim preferably for vehicles. The rim 12 has a pair of axially spaced rim flanges 60. The flanges 60 are spaced a distance. Each flange extends radially outwardly from a bead seat (64).

Axially inward of each bead seat is a bead hump 68. These humps 68 form an annular ridge that help keep the tire seated onto the bead seat by creating an obstruction to axially inward movement of the tire bead when the tire is operated without being inflated. Under normal inflated driving conditions, the tire is pushed axially outwardly against the flanges 60 while the radially inner surface of the tire's bead commonly referred to as the “toe” seals airtight against the inclined bead seat 64.

The industry standard rims typically specify that the inclined surface 78 preferably have a minimum inclination of 10 degrees off vertical.

Tire rims have a diametrically depressed middle portion 86 that facilitates the tire mounting procedure. Those skilled in the art commonly referred to this middle portion 86 as a “wheel well”. The wheel well is generally and preferably located closer to the outboard side of the rim. This means that the outboard bead seat and flange are generally axially closer to the mounting holes of the rim while the inboard side of the rim seat and flange are cantilevered axially inward from the mounting holes.

Ideally, the wheel well has an axial width. In the space between the wheel well and the axially inboard side of the rim, both the brake and disk caliper assembly are located. The rim manufacturers try to maximize the space between the wheel well and the inboard flange to accommodate the brakes.

As shown in FIG. 9A, the bead seat 64 has an axial width extending between the bead hump and the flange.

G. Rim Wire Passageway

FIG. 9B shows a close up of the wire passage 90 shown in FIGS. 6 and 9A. An “air tight seal” 95 is in the passage 90 to prevent air in the tire between the rim and a tire from escaping. The wire passage 90 has a tapered opening 90A on the 12A outside rim face and a taper opening 91B on the front face or inside rim face. The tapered opening helps make an air tight seal using sealant 95. The tapered opening can be formed using a drill bit with a larger diameter than the rim passageway 90.

The wire passage also preferably has a taper opening 90B on the inside rim face 12B. A purpose of the taper openings is to help form a better seal by the air pressure inside the tire pressing the sealant 95 into the smaller openings 90A and 90B.

The air pressure from the tire on the sealant 95 pushes that top portion of the sealant with the larger diameter into the passageway 90 with the smaller diameter.

The sealant is preferably a silicon composite. The wires 150 pass thru the rim passageway 90 and sealant 95.

H. Rim Light Passageway

Referring to FIG. 9C, a rim light passageway 91 (also called a vent sidewall hole 91) in the rim 12 with an vent opening in the front side of central portion 11. A rim light passageway 91 communicates between the outside rim face 12A and a vent sidewall 25 on the wheel front side 14. A light 52 is secured in the vent sidewall hole.

FIG. 9C shows an embodiment where the rim light passageway 91 has a tapered opening 91A and a narrow vent opening 91B. The vent sidewall holes preferably has a larger cross sectional area on the outside rim face than on the wheel front face. This helps form air tight seal.

Referring to FIG. 9C, an example is shown of the rim light passageway 91 with a smaller opening 91B at the vent sidewall 25 (or rim inside 12B. The LED can have a flange 52A that has a larger diameter than the opening 91B. The wires 150A connect from the groove wire 150 to the light 52. The entire groove hole 70A and sidewall vent hole 91 can be filled with sealer 95. The smaller diameter 91B 91A and the light flange 52A help the sealer form a reliable air tight seal.

A groove 70 is in the outside rim face 12A. Wires 150 are secured in the groove using a sealant 95.

Preferably, the groove 70 is not in the bead seat 64 of the outside face.

Sealer 95 is used at the opening to form an air tight seal.

L Example Electrical Schematic

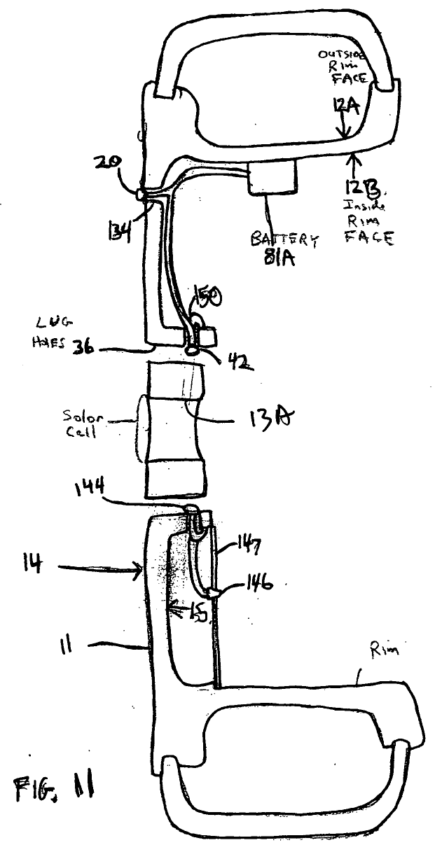

FIG. 10 shows an example electric schematic. FIG. 10 shows a power source (such solar cell or generator) and a battery connected in parallel. A rectifier or other device can be used to prevent the back flow of electricity. Lights (e.g., LEDs) can be connected in parallel or series. Preferably the wheel is used as a ground. Rivets can be used to fasten the ground wires to the wheel. A control circuit can be used to control the appearance of the lights. Also, a receiver can be included that can receive signals from a remote control that can be used to control the circuit.

A remote control means (e.g., transmitter) is functionally enabled for signaling a signal receiver for enabling the application of a current flow to illuminate the light.

The lighting device further comprises a signal receiver, a means for remote control functionally is enabled for signaling the signal receiver for enabling the application of a current flow to illuminate the light.

The control device (e.g., 58—FIG. 7) can further be a multifunction transmitter, such as a tire pressure transmitter and light transmitter.

Preferably, the lights (e.g. LED) and power source grounded to the wheel.

Preferably, the power supply is comprised of a battery, and solar cell or a generator.

1. Power Supply Options

The power supply can be comprised of a solar cell 30 mounted to the rim. The solar cell is preferably mounted about in the center of the rim.

The power supply is preferably comprised of a rechargeable battery mounted on the annular wheel rim. An example of a power supply is 4 AA batteries that are wrapped in heat shrink warp or protective coatings. The batteries can be connected by solder or other means, such as tape.

The power supply can be further comprised of a generator.

J. Option for Battery Mounted on the Inside Rim Face 12B

FIG. 11 shows option for battery 81A mounted on the inside rim face 12B. The batter is connected by wires to the lights 20 144. Light hole 134 and lug LED hole 144 hold lights 20.

FIG. 11 also shows an embodiment of a backside light 146 mounted on a back side panel 147 on the back face 15. The back side panel 147 can be made of metal and can over the wires. The backside light 146 faces about the direction of the back wheel face.

K. Option to Light

Furthermore, the lighted wheel rim system 10 may have light units which flash, blink, or flicker according to any pattern the user may desire, as well as the appropriate electronic elements to execute such patterns. The present invention may also include safety lights to insure safe operation of the vehicle under low visibility conditions, helping vehicle drivers overcome their blind spots when driving.

L. Fiber Optic Options

The embodiments can be optionally implemented using a version of fiber optics where the wires are fiber optic wires and the lights are the ends of the fiber optic wires. The power source is a light power source that transmits light thorough the fiber optic wires to the light wire ends that are mounted on the front face of the wheel. Fiber optic connections are electrical connects for purposes of the claims. (e.g., light is electromagnetic).

M. Importance of Lighted Wheels

The importance of decorative accoutrements and embellishments for vehicles is becoming increasingly evident. From 1990 to 1996, the sale of automotive accessories and performance equipment increased by forty-five percent to eighteen billion dollars. Many Americans commonly report that they spend more time in their cars and trucks than in their living rooms, and so believe that their vehicles should be appropriately personalized. One of the most popular forms of ornamentation is custom designed wheels, chrome wheels being a good example. Additionally, over the past few years, the popularity of the use of neon and other lighting elements has skyrocketed—from strobe lights and neon license plates to illuminated cargo areas and speakers, neon and similar automotive accessories have become a major fashion. D.O.T. studies have shown that side marker lamps on vehicles are associated with a significant decrease in the incident of accidents. Thus, a significant market exists for a rugged, durable, and practical accessory for providing an aesthetically pleasing illumination effect for the wheels of a vehicle, as well as for helping to insure the safety of drivers.

N. Review—An Example Embodiment of a Lighted Wheel

1. Wheel

Referring to figures all figures including 1, 6, 7, 8, 9A, 9B, and 9C, a wheel 10 is comprised of: a rim 12 and a center portion 11. The central portion 11 is preferably comprised of spokes 26 and a center hub 13.

The rim 12 preferably has an annular flange 60. The rim 12 has an outside rim face 12A and an inside rim face 12B. The central portion of the wheel has a front wheel face 14 and a back wheel face 15. For embodiments where the wheel is attached to a motor vehicle, the front wheel face points outward away from the side where a vehicle (e.g., car) and axle would be. The back wheel face faces the axle.

Referring to FIGS. 7 and 9A, the outside rim face 12A is preferably comprised of bead seats 64, flanges 60, and bead humps 60, and inclined surface 78. Felly is the portion of the rim between the flanges.

As shown in FIGS. 1 and 6, the central portion 11 can be comprised of spokes 26 and a center hub 13. The backside of spokes 26 can have cavities (channels or depressions) 130.

2. Lighting Device

The lighting device can be comprised of lights and a power supply, and wires that connect the lights to the power supply. In an option, lights (e.g., electrical light emitting device) are mounted on the front side of the wheel.

Referring to FIG. 7, a power supply 81 is attached to the wheel. The power source can be comprise of a battery. The battery can be mounted on the outside face 12A of the rim. A power supply 81 attached to the rim and the wires. The wires are connected to the lights by passageways through the rim.

3. Wiring System

A wiring system connects the power source 81 and the light(s). As shown in FIG. 6, the power source 81 is preferably positioned on the outside rim face 12A (enclosed by the tire).

The wires 150 that connect the power source and the light passes at least partially through the passageways (e.g., 68, 91, 144, 140). The connecting means preferably are comprised of electrical wires.

4. Passageways

A feature of some embodiment are passageways such as hub passageways 13A, rim passageways 90, and rim light passageway 91.

The passageways (e.g., 90, 91, 70A, 150, 140) through the wheel 10
(a) hub passageways 13A—hub passageway 13A communicating between inside hub wall 13B and the outside hub wall 13C;
(b) rim passageways 90 communicate from the front wheel face 14 to the back wheel face 15; and
(c) rim light passageway that communicate from the outside rim face 12A to the inside rim face 12B.

The lights are preferably mounted in at least some passageways on the front face of the wheel.

A. Hub Passageways 13A

As shown in FIGS. 3A and 3B, hub passageway 13A communicate between inside hub wall 13B and the outside hub wall 13C.

B. Rim Light Passageway 91 and Optional Groove Hole 70A

As shown in FIG. 9C, a rim light passageway 91 (also referred to as sidewall vent hole 91) communicates from the front wheel face 14 to the outside rim face 12B. It is noted that the rim light passageway 91 passes through both the rim 12 and the outside rim face 12B. A light is mounted in the Rim light passageway 91 in the vent sidewall 25 on the front wheel face 14. The groove hole 70A communications from groove 70 in the outside rim face 12B to the rim light passageway 91. Wires in the rim light passageway 91 and the groove hole 70A connect the vent light (FIG. 9C, 52) to the power supply.

C. Rim Wire Passageway 90

As shown in FIGS. 9A and 9B, a wire passage 90 communicates from the outside rim face 12A to the inside rim face 12B. Wires 150 in the passageway 90 that connect from the power source to the lights mounted on the front wheel face 14.

O. Non-Limiting Embodiments

The example embodiments can further include method of making and using the invention. The example embodiments disclose many elements. The elements can be combined in any combination possible. For example, a wheel can have a rim light passageway, but not a rim wire passageway. A wheel can have a rim wire passageway, but not a rim light passageway. A wheel can have any combination of passageways described herein.

Given the variety of embodiments of the present invention just described, the above description and illustrations show not be taken as limiting the scope of the present invention defined by the claims.

While the invention has been particularly shown and described with reference to the preferred embodiments thereof, it will be understood by those skilled in the art that various changes in form and details may be made without departing from the spirit and scope of the invention. It is intended to cover various modifications and similar arrangements and procedures, and the scope of the appended claims therefore should be accorded the broadest interpretation so as to encompass all such modifications and similar arrangements and procedures.

What is claimed is:

1. A wheel assembly comprising:
a wheel comprised of: a rim and a central portion;
said rim has an outside rim face and an inside rim face
said central portion comprised of a hub and spokes; said spokes connected to said rim and said hub;
a power source attached to said wheel;
at least a light attached to said wheel;
a connecting means for connecting the power source and said light.

2. The wheel assembly of claim 1 which further comprises;
said hub has a hub hole having a inside hub hole wall; and said hub having an outside hub wall;
a hub passageway communicating between inside hub wall and said outside hub wall;
said power source mounted in said hub hole;
said conducting means is comprised of at least a wire; said wire passes through said hub passageway.

3. The wheel assembly of claim 1 which further comprises;
a rim passageway through said rim communicating from said outside rim face and said inside rim face;
said power source attached to said outside rim face;
said conductive means comprises at least a wire passing through said rim passageway.

4. The wheel assembly of claim 1 which further comprises;
said hub has a hub hole having a inside hub hole wall; and said hub having an outside hub wall;
a hub passageway communicating between inside hub wall and said outside hub wall;
a rim passageway through said rim communicating from said outside rim face and said inside rim face;
said power source attached to said outside rim face;
said conductive means comprises at least a wire passing through said rim passageway or said hub passageway.

5. The wheel assembly of claim 1 wherein said central portion has a front wheel face and a back wheel face; said light is mounted on or in said front wheel face.

6. The wheel assembly of claim 1 which further comprises a control unit attached to said wheel.

7. The wheel assembly of claim 1 wherein said central portion has a front side and a back side;
a backside light is mounted facing out away from said wheel and away from said back side of said central panel.

8. A wheel assembly with a lighting device comprising:
a wheel comprised of: a rim and a central portion;
said rim has an outside rim face and an inside rim face;
said central portion comprised of a hub and spokes; said spokes connected to said rim and said hub;
said hub has a hub hole having a inside hub hole wall; and said hub having an outside hub wall;
a hub passageway communicating between inside hub wall and said outside hub wall;
a first wire passing through said hub passageway;
a power source attached to said wheel;
at least a light attached to said wheel;
a connecting means for connecting the power source and said light;
said conducting means is comprised of at least a wire.

9. The wheel assembly of claim 8 which further comprises:
a rim passageway through said rim communicating from said outside rim face and an inside rim face;
said power source attached to said outside rim face;
at least a portion of said wire passing through said rim passageway.

10. The wheel assembly of claim 8 which further includes:
said power supply comprised of a battery and a solar cell;
said solar cell mounted about in said hub hole of said hub;
battery and a light control module positioned on said rim;
a remote control to control said lights.
said hub further comprised of lug nut holes;
lights mounted in the sidewalls of said lug nut holes.

11. A wheel assembly with a lighting device comprising:
a wheel comprised of: a rim and a central portion; said rim has an outside rim face and an inside rim face; said central portion has a front wheel face and a back wheel face;
said central portion comprised of a hub and spokes; said spokes connected to said rim and said hub;
said hub has a hub hole having a inside hub hole wall; and said hub having an outside hub wall;
a power source attached to said wheel;
at least a light mounted on the wheel;
at least rim wire passageway at least through said rim;
a conducting means for connecting the power source and said light; said power source is positioned on the rim;
a wiring system for connecting the power source and said light; a wire passes through said passageway.

12. The wheel assembly of claim 11 which further comprises;
a hub passageway communicating between inside hub wall and said outside hub wall;
said power source is position on the outside rim face;
a rim light passageway that communicates between the outside rim face and a vent sidewall on said front wheel face;
a vent light is secured in said rim light passageway; said rim light passageway has a tapered opening;
wires are position within portions of said rim light passageway.

13. The wheel assembly of claim 11 which further comprises:
said rim passageway communicates from said outside rim face to said inside rim face;
a rim light passageway that communicates from the outside rim face to the inside rim face;
said lights mounted in at least an aperture on the front wheel face or the inside rim face of said wheel.

14. The wheel assembly of claim 11 which further includes a rim light passageway that communicates between the outside rim face and a vent sidewall on said wheel front side;
a vent light is secured in said rim light passageway; said rim light passageway has a tapered opening;
wires are position within portions of said rim light passageway.

15. The wheel assembly of claim 11 wherein said rim is comprised of a circumferential bead seat,
a circumferential groove in outside rim face of said rim whereby wires are positioned within circumferential said groove; said circumferential groove is not in said bead seat;
wires in said rim wire passageway that connect from said power source to said light mounted on the front wheel face.

16. The wheel assembly of claim 11 wherein
said power source is fixedly positioned on the outside rim face and enclosed by a tire,
a remote control means functionally enabled for signaling a signal receiver for enabling the application of a current flow to illuminate the light.
a signal receiver attached to said wheel.

17. The wheel assembly of claim 11 wherein said wheel further comprised of a lug nut hole; lights mounted in said lug nut holes.

18. The wheel assembly of claim 11 which further comprises;
a hub passageway communicates between inside hub wall and said outside hub wall;
said lights mounted in at least an aperture on the front wheel face or the inside rim face of said wheel;
said power source is position on the outside rim face;
a rim light passageway that communicates between the outside rim face and a vent sidewall on said wheel front side; a vent light is secured in said rim light passageway;
said rim light passageway has a tapered opening;
wires are position within portions of said rim light passageway said power supply comprised of a battery and a solar cell;
said solar cell mounted about in said hub hole of said hub;
battery and a light control module positioned on said rim;
a remote control to control said lights.
said hub further comprised of lug nut holes; lights mounted in the sidewalls of said lug nut holes.

19. The wheel assembly of claim 11 which further includes:
said power supply comprised of a battery and a solar cell mounted to said rim;
said solar cell mounted at least partially in said hub hole;
said battery and a light control module positioned on said rim to balance said rim;
a remote control to control said lights;
radio transmitter has modes to control speed, sound, pattern of the lights,
said wheel further comprised of lug nut holes; lights mounted in the sidewalls of said lug nut holes.
